(19) United States
(12) Patent Application Publication
(10) Pub. No.: US 2018/0207611 A1
(43) Pub. Date: Jul. 26, 2018

(54) PARTICULATE ADSORBENT MATERIAL AND METHODS OF MAKING THE SAME

(71) Applicant: Ingevity South Carolina, LLC, North Charleston, SC (US)

(72) Inventors: Timothy M. Byrne, North Charleston, SC (US); Marta Leon Garcia, Mount Pleasant, SC (US); Cameron I. Thomson, Charleston, SC (US); Laurence H. Hiltzik, Charleston, SC (US)

(21) Appl. No.: 15/656,643

(22) Filed: Jul. 21, 2017

Related U.S. Application Data
(60) Provisional application No. 62/450,480, filed on Jan. 25, 2017.

(51) Int. Cl. B01J 20/20; B01J 20/12; B01J 20/10; B01J 20/28; B01J 20/30; B01D 53/04

(52) U.S. Cl. CPC B01J 20/20; B01D 2257/702; B01J 20/10; B01J 20/28085; B01J 20/28092; B01J 20/28073; B01J 20/2803; B01J 20/3042; B01J 20/3064; B01J 20/3078; B01J 20/3007; B01D 53/04; B01D 2253/102; B01D 2253/11; B01J 20/12

(57) ABSTRACT

The present disclosure describes a particulate adsorbent material that includes: an adsorbent having microscopic pores with a diameter of <100 nm, macroscopic pores having a diameter of ≥100 nm, and a ratio of a volume of the macroscopic pores to a volume of the microscopic pores greater than about 150%, wherein the particulate adsorbent material has a retentivity of about ≤1.0 g/dL. A method of making the same includes: admixing an adsorbent with microscopic pores having a diameter <100 nm and a processing-aid that sublimates, vaporizes, chemically decomposes, solubilizes, or melts when heated to a temperature of ≥100° C.; and heating the mixture to about 100-1200° C. for about 0.25-24 hours forming macroscopic pores having a diameter of ≥100 nm when the processing-aid is sublimated, vaporized, chemically decomposed, solubilized, or melted, wherein a ratio of a volume of the macroscopic pores to a volume of the microscopic pores is >150%.

### CROSS-REFERENCE TO RELATED APPLICATIONS

This application claims priority to U.S. Provisional Application No. 62/450,480, filed on 25 Jan. 2017, the contents of which is incorporated herein by reference in their entirety.

### TECHNICAL FIELD

The present disclosure generally relates to particulate adsorbent material and methods of making the same. More particularly, the present disclosure relates to a particulate adsorbent material and methods of making the same for use in evaporative fuel vapor emission control systems.

### BACKGROUND

Evaporation of gasoline fuel from motor vehicle fuel systems is a major potential source of hydrocarbon air pollution. Such emissions can be controlled by the canister systems that employ activated carbon to adsorb the fuel vapor generated by the fuel systems. Under certain modes of engine operation, the adsorbed fuel vapor is periodically removed from the activated carbon by purging the canister systems with ambient air to desorb the fuel vapor from the activated carbon. The regenerated carbon is then ready to adsorb additional fuel vapor.

An increase in environmental concerns has continued to drive strict regulations of the hydrocarbon emissions from motor vehicles even when the vehicles are not operating. The vapor pressure in a vehicle fuel tank will increase as the ambient temperature increases while the vehicle is parked. Normally, to prevent the leaking of the fuel vapor from the vehicle into the atmosphere, the fuel tank is vented through a conduit to a canister containing suitable fuel adsorbent materials that can temporarily adsorb the fuel vapor. A mixture of fuel vapor and air from the fuel tank enters the canister through a fuel vapor inlet of the canister and expands or diffuses into the adsorbent volume where the fuel vapor is adsorbed in temporary storage and the purified air is released to the atmosphere through a vent port of the canister. Once the engine is turned on, ambient air is drawn into the canister system via manifold vacuum through the vent port of the canister. The purge air flows through the adsorbent volume inside the canister and desorbs the fuel vapor adsorbed on the adsorbent volume before entering the internal combustion engine through a fuel vapor purge conduit. The purge air does not desorb the entire fuel vapor adsorbed on the adsorbent volume, resulting in a residue hydrocarbon (“heel”) that may be emitted to the atmosphere. In addition, that heel in local equilibrium with the gas phase also permits fuel vapors from the fuel tank to migrate through the canister system as emissions. Such emissions typically occur when a vehicle has been parked and subjected to diurnal temperature changes over a period of several days, commonly called “diurnal breathing losses.” The California Low Emission Vehicle Regulations make it desirable for these diurnal breathing loss (DBL) emissions from the canister system to be below about 20 mg (“PZEV”) for a number of vehicles beginning with the 2003 model year and below about 50 mg, (“LEV-II”) for a larger number of vehicles beginning with the 2004 model year. Now the California Low Emission Vehicle Regulation (LEV-III) and EPAs Tier 3 Standard requires canister DBL emissions not to exceed 20 mg as per the Bleed Emissions Test Procedure (BETP) as written in the California Evaporative Emissions Standards and Test Procedures for 2001 and Subsequent Model Motor Vehicles, 22 Mar. 2012 and EPAs Control of Air Pollution From Motor Vehicles: Tier 3 Motor Vehicle Emission and Fuel Standards; Final Rule, 40 CFR Parts 79, 80, 85 et al.

Several approaches have been reported to reduce the diurnal breathing loss (DBL) emissions. One approach is to significantly increase the volume of purge gas to enhance desorption of the residue hydrocarbon heel from the adsorbent volume. This approach, however, has the drawback of complicating management of the fuel/air mixture to the engine during purge step and tends to adversely affect tailpipe emissions. See U.S. Pat. No. 4,894,072.

Another approach is to design the canister to have a relatively low cross-sectional area on the vent-side of the canister, either by the redesign of existing canister dimensions or by the installation of a supplemental vent-side canister of appropriate dimensions. This approach reduces the residual hydrocarbon heel by increasing the intensity of purge air. One drawback of such approach is that the relatively low cross-sectional area imparts an excessive flow restriction to the canister. See U.S. Pat. No. 5,957,114.

Another approach for increasing the purge efficiency is to heat the purge air, or a portion of the adsorbent volume having adsorbed fuel vapor, or both. However, this approach increases the complexity of control system management and poses some safety concerns. See U.S. Pat. Nos. 6,098,601 and 6,279,548.

Another approach is to route the fuel vapor through an initial adsorbent volume and then at least one subsequent adsorbent volume prior to venting to the atmosphere, wherein the initial adsorbent volume has a higher adsorption capacity than the subsequent adsorbent volume. See U.S. Pat. No. RE38,844.

Along the concept of adsorbents-in-series, adsorbent volumes with a gradation in adsorption working capacity with specific range of gram-total working capacity towards the system vent was found to be particularly useful for emission control canister systems to be operated under a low volume of purge, such as for “hybrid” vehicles, where the internal combustion engine is turned off nearly half of the time during vehicle operation and where the purge frequency is much less than normal. See WO 2014/059190 (PCT/US2013/064407).

Another approach along the concept of adsorbents-in-series is to provide a specially shaped particulate adsorbent with a specified ratio of volume of “macroscopic” pores to volume of “microscopic” pores (similar volumes of large pores to small pores) and with good adsorbing/desorbing properties, that also has low flow restriction, low level of vapor retention by the adsorbent, and sufficient strength. See U.S. Pat. No. 9,174,195. This approach is further described for emission control canister systems where the target is a mean pore size within a macroscopic size range. See U.S. Pat. No. 9,322,368. Both of these two approaches rely on the balance of shape, structural dimensions, and porosity ratio properties for attaining adequate particulate strength and adequate desorption of vapors, with the intention of reducing DBL emissions.

A common challenge and desire described by the above approaches, and others (see, e.g., U.S. Pat. No. 7,186,291 and U.S. Pat. No. 7,305,974), is countering the effect of the residual adsorbed vapors on the canister system performance, especially the DBL emissions performance, where the least amount of retained adsorbed vapors (lowest amount of heel) is highly sought. Furthermore, the deterioration of DBL emissions and of working capacity performance of canister systems (also called “ageing”) is also known to be due to accumulations of less purgeable components in this adsorbed vapor heel (see, e.g., SAE Technical Paper Series 2000-01-895). Therefore, the benefit of low retention of hydrocarbons after purge is twofold: a low level of DBL emissions for the new vehicle, and the maintenance of working capacity and emissions performance over the life of the vehicle.

While highly desirable as an approach, the combination of low cost, low complexity of production, high material structural strength, low flow restriction, and lowest vapor retention as engendered by a particulate adsorbent for evaporative emissions control is taught to be a restricted space. For example, as taught by U.S. Pat. No. 9,174,195, the useful range for the ratio of macroscopic to microscopic pore volumes is limited to between 65% and 150%, because of mechanical strength failing at higher ratio. Furthermore, within the claimed pore ratio range, the vapor retention (retentivity) is asymptotic, to greater than 1 g/dL as measured as residual amount of butane by a standard ASTM test, and greater than the noted 1.7 g/dL target when the pore ratio was beyond the claimed 150% limit, in addition to poor strength.

Accordingly, there remains a need for a particulate adsorbent that is of low cost, low complexity of production, has a high material structural strength, has a low flow restriction, and has the lowest vapor retention for evaporative emissions control so as to have low diurnal breathing loss (DBL) emissions performance and that has the required working capacity over the life of the vehicle.

### SUMMARY

Presently described are particulate adsorbent material for evaporative emission control with surprising and unexpected characteristics, such as low retentivity and superior strength. As such, in one aspect the description provides a particulate adsorbent material for evaporative emission control. In general, the material comprises: an adsorbent having microscopic pores with a diameter of less than about 100 nm; macroscopic pores having a diameter of about 100 nm or greater; and a ratio of a volume of the macroscopic pores to a volume of the microscopic pores that is greater than about 150%, wherein the particulate adsorbent material has a retentivity of about 1.0 g/dL or less.

In some embodiments, the adsorbent has a retentivity of about 0.75 g/dL or less.

In certain embodiments, the adsorbent has a retentivity of about 0.25 to about 1.00 g/dL.

In further embodiments, the adsorbent is at least one of activated carbon, carbon charcoal, molecular sieves, porous polymers, porous alumina, clay, porous silica, kaolin, zeolites, metal organic frameworks, titania, ceria, or a combination thereof.

In a particular embodiment, the adsorbent has a micropore volume of about 0.5 cc/g or less (about 225 cc/L or less).

In some other embodiments, the adsorbent comprises a body defining an exterior surface and a three-dimensional low flow resistance shape or morphology.

In certain other embodiments, the three-dimensional low flow resistance shape or morphology is at least one of substantially a cylinder, substantially an oval prism, substantially a sphere, substantially a cube, substantially an elliptical prism, substantially a rectangular prism, a lobed prism, a three-dimensional helix or spiral, or a combination thereof.

In further embodiments, the particulate adsorbent material has a cross-sectional width of about 1 mm to about 20 mm.

In a certain embodiment, the cross-sectional width is about 4 mm to about 8 mm (e.g., about 5 mm to about 8 mm).

In another embodiment, the adsorbent includes at least one cavity in fluid communication with the exterior surface of the adsorbent.

In other embodiments, the adsorbent has a hollow shape in cross section.

In an embodiment, the adsorbent includes at least one channel in fluid communication with at least one exterior surface.

In certain further embodiments, each part of the adsorbent has a thickness of about 3.0 mm or less.

In an embodiment, at least one exterior wall of the hollow shape has a thickness of about 1.0 mm or less.

In yet other embodiments, the hollow shape has at least one interior wall extending between the exterior walls and having a thickness of about 1.0 mm or less.

In a particular embodiment, the thickness of at least one of the interior wall, the exterior wall or a combination thereof is about 1.0 mm or less, about 0.75 mm or less, about 0.6 mm or less, about 0.5 mm or less, or about 0.4 mm or less.

In further embodiments, the thickness of at least one of the interior wall, the exterior wall or a combination thereof is in a range of about 0.1 mm to about 0.6 mm, about 0.1 mm to about 0.4 mm, or about 0.1 mm to about 0.3 mm.

In some embodiments, the interior wall extends outward to the exterior wall in at least two directions from a hollow portion of the particulate adsorbent material (such as, from a center of the particulate adsorbent material).

In some other embodiments, the interior walls extends outward to the exterior wall in at least three directions from a hollow portion of the particulate adsorbent material (such as, from a center of the particulate adsorbent material).

In an embodiments, the interior walls extends outward to the exterior wall in at least four directions from a hollow portion of the particulate adsorbent material (such as, from a center of the particulate adsorbent material).

In certain embodiments, the adsorbent has a length of about 1 mm to about 20 mm.

In particular embodiments, the length is about 2 mm to about 8 mm (e.g., the length is about 3 mm to about 7 mm).

In a further embodiment, the activated carbon is derived from at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, synthetic polymer, natural polymer, lignocellulosic material, and combinations thereof.

In yet other embodiments, the particulate adsorbent further comprises at least one of: a pore forming material or processing aid that sublimates, vaporizes, chemically decomposes, solubilizes or melts to form at least one void (e.g., 1, 2, 3, 4, 5, 6, 7, 8, 9, 10, 11, 12, 13, 14, 15, or more voids); a binder; a filler; or a combination thereof.

In a certain embodiment, the pore forming material or processing aid is a cellulose derivative.

In another embodiment, the pore forming material or processing aid is methylcellulose.

In an embodiment, the pore forming material or processing aid sublimates, vaporizes, chemically decomposes, solubilizes or melts when heated to a temperature in a range of about 125° C. to about 640° C.

In some further embodiment, the binder is clay or a silicate material.

In some embodiments, the clay is at least one of Zeolite clay, Bentonite clay, Montmorillonite clay, Elite clay, French Green clay, Pascalite clay, Redmond clay, Terramin clay, Living clay, Fuller's Earth clay, Ormalite clay, Vitallite clay, Rectorite clay, Cordierite, kaolin clay, ball clay or a combination thereof.

In a particular embodiment, a packed bed of the particulate adsorbent material has a pressure drop that is <40 Pa/cm at 46 cm/s apparent linear air flow velocity.

In another aspect, the present disclosure provides a method of preparing a particulate adsorbent material. The method comprising: admixing an adsorbent with microscopic pores having a diameter less than about 100 nm and a pore forming material or processing aid that sublimates, vaporizes, chemically decomposes, solubilizes or melts when heated to a temperature of 100° C. or more; and heating the mixture to a temperature in a range of about 100° C. to about 1200° C. for about 0.25 hours to about 24 hours, thereby forming macroscopic pores having a diameter of about 100 nm or greater when the core material is sublimated, vaporized, chemically decomposes, solubilizes or melted, wherein a ratio of a volume of the macroscopic pores to a volume of the microscopic pores in the adsorbent is greater than 150%.

In some embodiments, the particulate adsorbent material has a retentivity of about 1.0 g/dL or less.

In further embodiments, the method further comprises extruding or compressing the mixture into a shaped structure.

In yet another embodiment, the adsorbent is at least one of activated carbon, molecular sieves, porous alumina, clay, porous silica, zeolites, metal organic frameworks, or a combination thereof.

In other embodiments, the mixture further comprises a binder.

In an embodiment, the binder is at least one of clay, silicate or a combination thereof.

In further embodiments, the mixture further comprises a filler.

In a particular embodiment, the filler have a three-dimensional volume or shape or morphology.

In some other embodiments, the adsorbent has a cross-sectional width in a range of about 1 mm to about 20 mm.

In a particular embodiment, the adsorbent comprises a body defining an exterior surface and a three-dimensional low flow resistant shape or morphology.

In an embodiment, the three-dimensional low flow resistant shape or morphology is at least one of substantially a cylinder, substantially an oval prism, substantially a sphere, substantially a cube, substantially an elliptical prism, substantially a rectangular prism, a lobed prism, a three-dimensional helix or spiral, or a combination thereof.

In yet another embodiment, the adsorbent includes at least one cavity or channel in fluid communication with an exterior surface of the adsorbent.

In certain embodiments, the adsorbent has hollow shape in cross section.

In a particular embodiment, each part of the adsorbent has a thickness of about 3.0 mm or less.

In other embodiments, an exterior wall of the hollow shape has a thickness of about 1.0 mm or less.

In some embodiments, the hollow shape has interior walls extending between the exterior walls.

In an embodiment, the interior walls have a thickness of about 1.0 mm or less.

In another embodiment, at least one of the interior walls, at least one of the exterior wall, or a combination thereof is about 1.0 or less, about 0.6 mm or less, or about 0.4 mm or less.

In yet another embodiment, the interior walls extend outward to the exterior wall in at least two directions from the interior volume (such as, from the hollow portion), such as a center.

In yet a further embodiment, the interior walls extend outward to the exterior wall in at least three directions from the interior volume (such as, from the hollow portion), such as a center.

In a particular embodiment, the interior wall extends outward to the exterior wall in at least four directions from the interior volume (such as, from the hollow portion), such as a center.

In some embodiments, the adsorbent has a length of about 1 mm to about 20 mm.

In certain embodiment, the length of the adsorbent is in a range of about 2 mm to about 8 mm (e.g., the length is about 3 mm to about 7 mm).

In a further aspect, the present disclosure provides for a particulate adsorbent material produced by the method of the present disclosure.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure may be utilized in numerous combinations, all of which are expressly contemplated by the present disclosure. These additional advantages objects and embodiments are expressly included within the scope of the present disclosure. The publications and other materials used herein to illuminate the background of the disclosure, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating an embodiment of the disclosure and are not to be construed as limiting the disclosure. Further objects, features and advantages of the disclosure will become apparent from the following detailed description taken in conjunction with the accompanying figures showing illustrative embodiments of the disclosure, in which:

FIGS. 1A, 1B, 1C, 1D, 1E, 1F, 1G, 1H1, 1H2, and 1I illustrate examples of alternative adsorbent morphologies;

FIG. 2 is a graph of retentivity (g/dL) versus porosity ratio (i.e., a ratio of a volume of macroscopic pores of about 100 nm or greater to a volume of microscopic pores of less than 100 nm);

FIG. 3 is a graph of 2 mm strength versus porosity ratio (i.e., a ratio of a volume of macroscopic pores of about 100 nm or greater to a volume of microscopic pores of less than 100 nm);

FIG. 4 is a cross-sectional view of an apparatus for measuring pressure drop produced by the particulate adsorbent; and

FIG. 5 is a graph of pressure drop (Pa/cm) at 40 L/min versus nominal pellet outer diameter (mm).

### DETAILED DESCRIPTION OF THE INVENTION

The present disclosure will now be described more fully hereinafter, but not all embodiments of the disclosure are shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular structure or material to the teachings of the disclosure without departing from the essential scope thereof.

The drawings accompanying the application are for illustrative purposes only. They are not intended to limit the embodiments of the present disclosure. Additionally, the drawings are not drawn to scale. Elements common between figures may retain the same numerical designation.

Where a range of values is provided, it is understood that each intervening value between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

As used herein, the terms “gaseous” and “vaporous” are used in a general sense and, unless the context indicates otherwise, are intended to be interchangeable.

One aspect the description provides a particulate adsorbent material, which may be used for, e.g., evaporative emission control. In general, the material comprises: an adsorbent having microscopic pores with a diameter of less than about 100 nm; macroscopic pores having a diameter of about 100 nm or greater; and a ratio of a volume of the macroscopic pores to a volume of the microscopic pores that is greater than about 150%, wherein the particulate adsorbent material has a retentivity of about 1.0 g/dL or less.

For example, the adsorbent may have a retentivity of about 0.75 g/dL or less, about 0.50 g/dL or less, or about 0.25 g/dL or less. By way of further example, the adsorbent may have a retentivity of about 0.25 g/dL to about 1.00 g/dL, about 0.25 g/dL to about 0.75 g/dL, about 0.25 g/dL to about 0.50 g/dL, about 0.50 g/dL to about 1.00 g/dL, about 0.50 g/dL to about 0.75 g/dL, or about 0.75 g/dL to about 1.00 g/dL.

In certain embodiments, the ratio of volumes is: at least about 160%, at least about 170%, at least about 180%, at least about 190%, at least about 200%, at least about 225%, at least 250 at least 275, at least 300 or at least about 350%. In other embodiments, the ratio of volumes is greater than about 150% to about 1000%, greater than about 150% to about 800%, greater than about 150% to about 600%, greater than about 150% to about 500%, greater than about 150% to about 400%, greater than about 150% to about 300%, greater than about 150% to about 200%, about 175% to about 1000%, about 175% to about 800%, about 175% to about 600%, about 175% to about 500%, about 175% to about 400%, about 175% to about 300%, about 175% to about 200%, about 200% to about 800%, about 200% to about 600%, about 200% to about 500%, about 200% to about 400%, about 200% to about 300%, about 300% to about 800%, about 300% to about 600%, about 300% to about 500%, about 300% to about 400%, about 400% to about 800%, about 400% to about 600%, about 400% to about 500%, about 500% to about 800%, about 500% to about 600%, or about 600% to about 800%.

The adsorbent may be at least one of activated carbon (which may be derived from at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, synthetic polymer, natural polymer, lignocellulosic material, and combinations thereof), carbon charcoal, molecular sieves, porous polymers, porous alumina, clay, porous silica, kaolin, zeolites, metal organic frameworks, titania, ceria, or a combination thereof.

In a particular embodiment, the adsorbent has a micropore volume of about 225 cc/L or less (about 0.5 cc/g or less). For example, the micropore volume may be less than or equal to about 200 cc/L, less than or equal to about 175 cc/L, less than or equal to about 150 cc/L, less than or equal to about 125 cc/L, less than or equal to about 100 cc/L, less than or equal to about 75 cc/L, less than or equal to about 50 cc/L, or less than or equal to about 25 cc/L. By way of further example, the micropore volume may be about 1.0 cc/L to about 225 cc/L, about 1.0 cc/L to about 200 cc/L, about 1.0 cc/L to about 175 cc/L, about 1.0 cc/L to about 150 cc/L, about 1.0 cc/L to about 125 cc/L, about 1.0 cc/L to about 100 cc/L, about 1.0 cc/L to about 75 cc/L, about 1.0 cc/L to about 50 cc/L, about 1.0 cc/L to about 25 cc/L, about 25 cc/L to about 225 cc/L, about 25 cc/L to about 200 cc/L, about 25 cc/L to about 175 cc/L, about 25 cc/L to about 150 cc/L, about 25 cc/L to about 125 cc/L, about 25 cc/L to about 100 cc/L, about 25 cc/L to about 75 cc/L, about 25 cc/L to about 50 cc/L, about 50 cc/L to about 225 cc/L, about 50 cc/L to about 200 cc/L, about 50 cc/L to about 175 cc/L, about 50 cc/L to about 150 cc/L, about 50 cc/L to about 125 cc/L, about 50 cc/L to about 100 cc/L, about 50 cc/L to about 75 cc/L, about 75 cc/L to about 225 cc/L, about 75 cc/L to about 200 cc/L, about 75 cc/L to about 175 cc/L, about 75 cc/L to about 150 cc/L, about 75 cc/L to about 125 cc/L, about 75 cc/L to about 100 cc/L, about 100 cc/L to about 225 cc/L, about 100 cc/L to about 200 cc/L, about 100 cc/L to about 175 cc/L, about 100 cc/L to about 150 cc/L, about 100 cc/L to about 125 cc/L, about 125 cc/L to about 225 cc/L, about 125 cc/L to about 200 cc/L, about 125 cc/L to about 175 cc/L, about 125 cc/L to about 150 cc/L, about 150 cc/L to about 225 cc/L, about 150 cc/L to about 200 cc/L, about 150 cc/L to about 175 cc/L, about 175 cc/L to about 225 cc/L, about 175 cc/L to about 200 cc/L, or about 200 cc/L to about 225 cc/L.

In some other embodiments, the adsorbent comprises a body defining an exterior surface and a three-dimensional low flow resistance shape or morphology. The three-dimensional low flow resistance shape or morphology may be any shape or morphology that one skilled in the art would appreciate has low flow resistance. For example, the three-dimensional low flow resistance shape or morphology may be at least one of substantially a cylinder, substantially an oval prism, substantially a sphere, substantially a cube, substantially an elliptical prism, substantially a rectangular prism, a lobed prism, a three-dimensional helix or spiral, or a combination thereof. Other useful examples of the morphology include shapes known to those skilled in the art of absorption column packings, and include Rachig rings, cross partition rings, Pall® rings, Intalox® saddles, Berl saddles, Super Intalox® saddles, Conjugate rings, Cascade mini rings, and Lessing rings. Other useful examples of the morphology include shapes known to those skilled in the art of pasta making, and may include ribbon, solid, hollow, lobed, and lobed-hollow composite shapes of strips, springs, coils, corkscrews, shells, tubes, such as gemelli, fusilli, fusilli col buco, macaroni, rigatoni, cellentani, farfalle, gomiti rigatti, casarecci, cavatelli, creste di galli, gigli, lumaconi, quadrefiore, radiatore, mote, conchiglie, or a combination thereof.

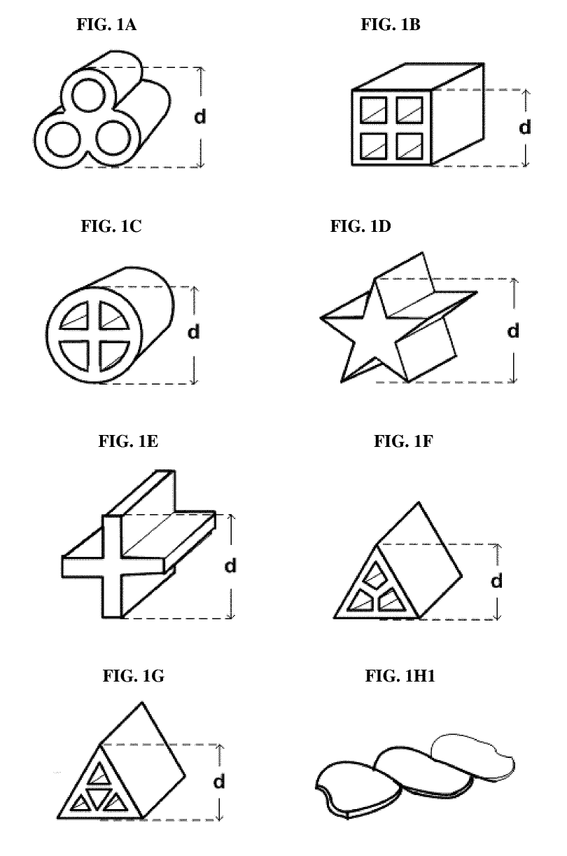

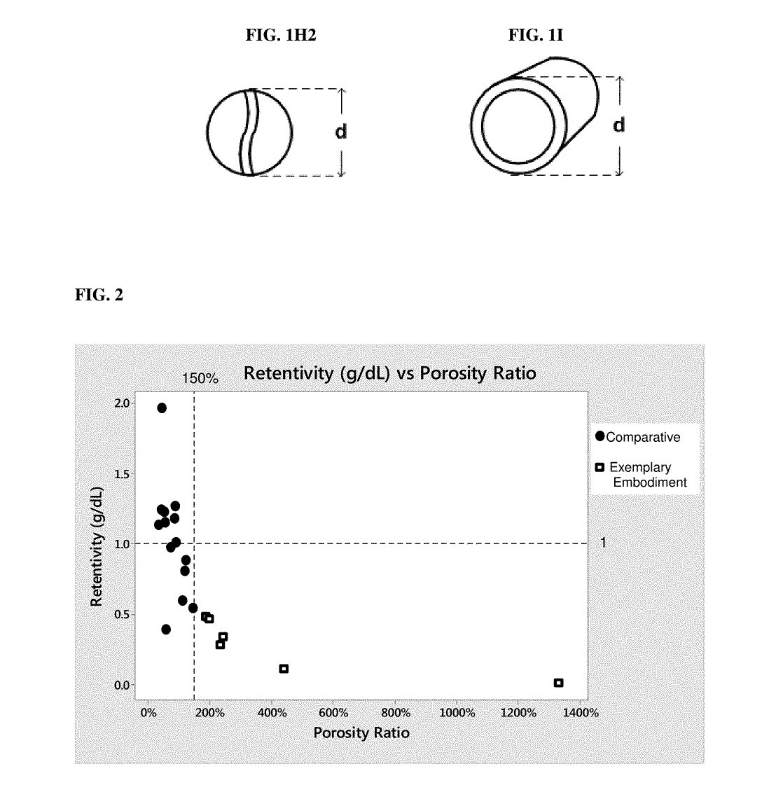

By way of non-limiting examples, FIGS. 1A through 1I show exemplary shape morphologies of the present disclosure, including a composite lobed shape (A), a square prism shape (B), a cylinder shape (C), a shape with a star cross-section (D), a cross cross-section (E), a triangular prism with interior walls that transverse the center axis (F), a triangular prism with interior walls that do not transverse the center axis (G), a helical or twisted ribbon shape (H1 with an on-end appearance of H2), and a hollow cylinder (I).

The particulate adsorbent material may have a cross-sectional width of about 1 mm to about 20 mm (e.g., about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm about 17 mm, about 18 mm, about 19 mm, or about 20 mm). In a particulate embodiment, the cross-sectional width is about 1 mm to about 18 mm, about 1 mm to about 16 mm, about 1 mm to about 14 mm, about 1 mm to about 12 mm, about 1 mm to about 10 mm, about 1 mm to about 8 mm, about 1 mm to about 6 mm, about 1 mm to about 4 mm, about 1 mm to about 3 mm, about 2 mm to about 20 mm, about 2 mm to about 18 mm, about 2 mm to about 16 mm, about 2 mm to about 14 mm, about 2 mm to about 12 mm, about 2 mm to about 10 mm, about 2 mm to about 8 mm, about 2 mm to about 6 mm, about 2 mm to about 4 mm, about 4 mm to about 20 mm, about 4 mm to about 18 mm, about 4 mm to about 16 mm, about 4 mm to about 14 mm, about 4 mm to about 12 mm, about 4 mm to about 10 mm, about 4 mm to about 8 mm, about 4 mm to about 6 mm, about 6 mm to about 20 mm, about 6 mm to about 18 mm, about 6 mm to about 16 mm, about 6 mm to about 14 mm, about 6 mm to about 12 mm, about 6 mm to about 10 mm, about 6 mm to about 8 mm, about 8 mm to about 20 mm, about 8 mm to about 18 mm, about 8 mm to about 16 mm, about 8 mm to about 14 mm, about 8 mm to about 12 mm, about 8 mm to about 10 mm, about 10 mm to about 20 mm, about 10 mm to about 18 mm, about 10 mm to about 16 mm, about 10 mm to about 14 mm, about 10 mm to about 12 mm, about 12 mm to about 20 mm, about 12 mm to about 18 mm, about 12 mm to about 16 mm, about 12 mm to about 14 mm, about 14 to about 20 mm, about 14 mm to about 18 mm, about 14 mm to about 16 mm, about 16 mm to about 20 mm, about 16 mm to about 18 mm, or about 18 mm to about 20 mm.

The adsorbent may include at least one cavity in fluid communication with the exterior surface of the adsorbent.

The adsorbent may have a hollow shape in cross section.

The adsorbent may include at least one channel in fluid communication with at least one exterior surface.

In certain further embodiments, each part of the adsorbent has a thickness equal to or less than about 3.0 mm. For example, each part of the adsorbent may have a thickness equal to or less than 2.5 mm, equal to or less than 2.0 mm, equal to or less than 1.5 mm, equal to or less than 1.25 mm, equal to or less than 1.0 mm, equal to or less than 0.75 mm, equal to or less than 0.5 mm, or equal to or less than 0.25 mm. That is, each part of the adsorbent may have a thickness of about 0.1 mm to about 3 mm, about 0.1 mm to about 2.5 mm, about 0.1 mm to about 2.0 mm, about 0.1 mm to about 1.5 mm, about 0.1 mm to about 1.0 mm, about 0.1 mm to about 0.5 mm, about 0.2 mm to about 3 mm, about 0.2 mm to about 2.5 mm, about 0.2 mm to about 2.0 mm, about 0.2 mm to about 1.5 mm, about 0.2 mm to about 1.0 mm, about 0.2 mm to about 0.5 mm, about 0.4 mm to about 3 mm, about 0.4 mm to about 2.5 mm, about 0.4 mm to about 2.0 mm, about 0.4 mm to about 1.5 mm, about 0.4 mm to about 1.0 mm, about 0.4 mm to about 3 mm, about 0.4 mm to about 2.5 mm, about 0.4 mm to about 2.0 mm, about 0.4 mm to about 1.5 mm, about 0.4 mm to about 1.0 mm, about 0.75 mm to about 3 mm, about 0.75 mm to about 2.5 mm, about 0.75 mm to about 2.0 mm, about 0.75 mm to about 1.5 mm, about 0.75 mm to about 1.0 mm, about 1.25 mm to about 3 mm, about 1.25 mm to about 2.5 mm, about 1.25 mm to about 2.0 mm, about 2.0 mm to about 3 mm, about 2.0 mm to about 2.5 mm, or about 2.5 mm to about 3.0 mm.

In an embodiment, at least one exterior wall of the hollow shape has a thickness equal to or less than about 1.0 mm (e.g., about 0.1 mm, about 0.2 mm, about 0.3 mm, about 0.4 mm, about 0.5 mm, about 0.6 mm, about 0.7 mm, about 0.8 mm, about 0.9 mm, or about 1.0 mm). For example, an exterior wall of the hollow shape may have a thickness in a range of about 0.1 mm to about 1.0 mm, about 0.1 mm to about 0.9 mm, about 0.1 mm to about 0.8 mm, about 0.1 mm to about 0.7 mm, about 0.1 mm to about 0.6 mm, about 0.1 mm to about 0.5 mm, about 0.1 mm to about 0.4 mm, about 0.1 mm to about 0.3 mm, about 0.1 mm to about 0.2 mm, about 0.2 mm to about 1.0 mm, about 0.2 mm to about 0.9 mm, about 0.2 mm to about 0.8 mm, about 0.2 mm to about 0.7 mm, about 0.2 mm to about 0.6 mm, about 0.2 mm to about 0.5 mm, about 0.2 mm to about 0.4 mm, about 0.2 mm to about 0.3 mm, about 0.3 mm to about 1.0 mm, about 0.3 mm to about 0.9 mm, about 0.3 mm to about 0.8 mm, about 0.3 mm to about 0.7 mm, about 0.3 mm to about 0.6 mm, about 0.3 mm to about 0.5 mm, about 0.3 mm to about 0.4 mm, about 0.4 mm to about 1.0 mm, about 0.4 mm to about 0.9 mm, about 0.4 mm to about 0.8 mm, about 0.4 mm to about 0.7 mm, about 0.4 mm to about 0.6 mm, about 0.4 mm to about 0.5 mm, about 0.5 mm to about 1.0 mm, about 0.5 mm to about 0.9 mm, about 0.5 mm to about 0.8 mm, about 0.5 mm to about 0.7 mm, about 0.5 mm to about 0.6 mm, about 0.6 mm to about 1.0 mm, about 0.6 mm to about 0.9 mm, about 0.6 mm to about 0.8 mm, about 0.6 mm to about 0.7 mm, about 0.7 mm to about 1.0 mm, about 0.7 mm to about 0.9 mm, about 0.7 mm to about 0.8 mm, about 0.8 mm to about 1.0 mm, about 0.8 mm to about 0.9 mm, or about 0.9 mm to about 1.0 mm.

In yet other embodiments, the hollow shape has at least one interior wall extending between the exterior walls and having a thickness equal to or less than about 1.0 mm (e.g., about 0.1 mm, about 0.2 mm, about 0.3 mm, about 0.4 mm, about 0.5 mm, about 0.6 mm, about 0.7 mm, about 0.8 mm, about 0.9 mm, or about 1.0 mm). For example, an interior wall may have a thickness in a range of about 0.1 mm to about 1.0 mm, about 0.1 mm to about 0.9 mm, about 0.1 mm to about 0.8 mm, about 0.1 mm to about 0.7 mm, about 0.1 mm to about 0.6 mm, about 0.1 mm to about 0.5 mm, about 0.1 mm to about 0.4 mm, about 0.1 mm to about 0.3 mm, about 0.1 mm to about 0.2 mm, about 0.2 mm to about 1.0 mm, about 0.2 mm to about 0.9 mm, about 0.2 mm to about 0.8 mm, about 0.2 mm to about 0.7 mm, about 0.2 mm to about 0.6 mm, about 0.2 mm to about 0.5 mm, about 0.2 mm to about 0.4 mm, about 0.2 mm to about 0.3 mm, about 0.3 mm to about 1.0 mm, about 0.3 mm to about 0.9 mm, about 0.3 mm to about 0.8 mm, about 0.3 mm to about 0.7 mm, about 0.3 mm to about 0.6 mm, about 0.3 mm to about 0.5 mm, about 0.3 mm to about 0.4 mm, about 0.4 mm to about 1.0 mm, about 0.4 mm to about 0.9 mm, about 0.4 mm to about 0.8 mm, about 0.4 mm to about 0.7 mm, about 0.4 mm to about 0.6 mm, about 0.4 mm to about 0.5 mm, about 0.5 mm to about 1.0 mm, about 0.5 mm to about 0.9 mm, about 0.5 mm to about 0.8 mm, about 0.5 mm to about 0.7 mm, about 0.5 mm to about 0.6 mm, about 0.6 mm to about 1.0 mm, about 0.6 mm to about 0.9 mm, about 0.6 mm to about 0.8 mm, about 0.6 mm to about 0.7 mm, about 0.7 mm to about 1.0 mm, about 0.7 mm to about 0.9 mm, about 0.7 mm to about 0.8 mm, about 0.8 mm to about 1.0 mm, about 0.8 mm to about 0.9 mm, or about 0.9 mm to about 1.0 mm.

In a particular embodiment, the thickness of at least one of the interior wall, the exterior wall or a combination thereof is equal to or less than about 1.0 mm (e.g., about 0.1 mm, about 0.2 mm, about 0.3 mm, about 0.4 mm, about 0.5 mm, about 0.6 mm, about 0.7 mm, about 0.8 mm, about 0.9 mm, or about 1.0 mm). For example, the thickness of at least one of the interior wall, the exterior wall or a combination thereof is equal to or less than about 1.0 mm, equal to or less than about 0.6 mm, or equal to or less than about 0.4 mm. In certain embodiments, at least one of the interior wall, the exterior wall, or a combination thereof has a thickness in a range of about 0.1 mm to about 1.0 mm, about 0.1 mm to about 0.9 mm, about 0.1 mm to about 0.8 mm, about 0.1 mm to about 0.7 mm, about 0.1 mm to about 0.6 mm, about 0.1 mm to about 0.5 mm, about 0.1 mm to about 0.4 mm, about 0.1 mm to about 0.3 mm, about 0.1 mm to about 0.2 mm, about 0.2 mm to about 1.0 mm, about 0.2 mm to about 0.9 mm, about 0.2 mm to about 0.8 mm, about 0.2 mm to about 0.7 mm, about 0.2 mm to about 0.6 mm, about 0.2 mm to about 0.5 mm, about 0.2 mm to about 0.4 mm, about 0.2 mm to about 0.3 mm, about 0.3 mm to about 1.0 mm, about 0.3 mm to about 0.9 mm, about 0.3 mm to about 0.8 mm, about 0.3 mm to about 0.7 mm, about 0.3 mm to about 0.6 mm, about 0.3 mm to about 0.5 mm, about 0.3 mm to about 0.4 mm, about 0.4 mm to about 1.0 mm, about 0.4 mm to about 0.9 mm, about 0.4 mm to about 0.8 mm, about 0.4 mm to about 0.7 mm, about 0.4 mm to about 0.6 mm, about 0.4 mm to about 0.5 mm, about 0.5 mm to about 1.0 mm, about 0.5 mm to about 0.9 mm, about 0.5 mm to about 0.8 mm, about 0.5 mm to about 0.7 mm, about 0.5 mm to about 0.6 mm, about 0.6 mm to about 1.0 mm, about 0.6 mm to about 0.9 mm, about 0.6 mm to about 0.8 mm, about 0.6 mm to about 0.7 mm, about 0.7 mm to about 1.0 mm, about 0.7 mm to about 0.9 mm, about 0.7 mm to about 0.8 mm, about 0.8 mm to about 1.0 mm, about 0.8 mm to about 0.9 mm, or about 0.9 mm to about 1.0 mm.

In some embodiments, the interior wall extends outward to the exterior wall in at least two directions from a hollow portion of the particulate adsorbent material (such as, from a center of the particulate adsorbent material).

For example, the interior walls may extend outward to the exterior wall in at least three directions from a hollow portion of the particulate adsorbent material (such as, from a center of the particulate adsorbent material) or at least four directions from a hollow portion of the particulate adsorbent material (such as, from a center of the particulate adsorbent material).

In certain embodiments, the particulate adsorbent material may have a length of about 1 mm to about 20 mm (e.g., about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm about 17 mm, about 18 mm, about 19 mm, or about 20 mm). In a particular embodiment, the length is about 1 mm to about 18 mm, about 1 mm to about 16 mm, about 1 mm to about 14 mm, about 1 mm to about 12 mm, about 1 mm to about 10 mm, about 1 mm to about 8 mm, about 1 mm to about 6 mm, about 1 mm to about 4 mm, about 1 mm to about 3 mm, about 2 mm to about 20 mm, about 2 mm to about 18 mm, about 2 mm to about 16 mm, about 2 mm to about 14 mm, about 2 mm to about 12 mm, about 2 mm to about 10 mm, about 2 mm to about 8 mm, about 2 mm to about 6 mm, about 2 mm to about 4 mm, about 4 mm to about 20 mm, about 4 mm to about 18 mm, about 4 mm to about 16 mm, about 4 mm to about 14 mm, about 4 mm to about 12 mm, about 4 mm to about 10 mm, about 4 mm to about 8 mm, about 4 mm to about 6 mm, about 6 mm to about 20 mm, about 6 mm to about 18 mm, about 6 mm to about 16 mm, about 6 mm to about 14 mm, about 6 mm to about 12 mm, about 6 mm to about 10 mm, about 6 mm to about 8 mm, about 8 mm to about 20 mm, about 8 mm to about 18 mm, about 8 mm to about 16 mm, about 8 mm to about 14 mm, about 8 mm to about 12 mm, about 8 mm to about 10 mm, about 10 mm to about 20 mm, about 10 mm to about 18 mm, about 10 mm to about 16 mm, about 10 mm to about 14 mm, about 10 mm to about 12 mm, about 12 mm to about 20 mm, about 12 mm to about 18 mm, about 12 mm to about 16 mm, about 12 mm to about 14 mm, about 14 to about 20 mm, about 14 mm to about 18 mm, about 14 mm to about 16 mm, about 16 mm to about 20 mm, about 16 mm to about 18 mm, or about 18 mm to about 20 mm.

The particulate adsorbent may further comprise at least one of: a pore forming material or processing aid that sublimates, vaporizes, chemically decomposes, solubilizes, or melts when heated to a temperature of 100° C. or more; a binder; a filler; or a combination thereof.

In a particular embodiment, the particulate adsorbent comprises at least one of: about 5% to about 60% of adsorbent, about 60% or less of a filler, about 6% or less of the pore forming material (or processing aid), about 10% or less of silicate, about 5% to about 70% of clay, or a combination thereof. The adsorbent may be present in about 5% to about 60%, about 5% to about 50%, about 5% to about 40%, about 5% to about 30%, about 5% to about 20%, about 5% to about 10%, about 10% to about 60%, about 10% to about 50%, about 10% to about 40%, about 10% to about 30%, about 10% to about 20%, about 20% to about 60%, about 20% to about 50%, about 20% to about 40%, about 20% to about 30%, about 30% to about 60%, about 30% to about 50%, about 30% to about 40%, about 40% to about 60%, about 40% to about 50%, or about 50% to about 60% of the particulate adsorbent material.

The filler may be present in less than or equal to about 60%, less than or equal to about 50%, less than or equal to about 40%, less than or equal to about 30%, less than or equal to about 20%, less than or equal to about 10%, about 5% to about 60%, about 5% to about 50%, about 5% to about 40%, about 5% to about 30%, about 5% to about 20%, about 5% to about 10%, about 10% to about 60%, about 10% to about 50%, about 10% to about 40%, about 10% to about 30%, about 10% to about 20%, about 20% to about 60%, about 20% to about 50%, about 20% to about 40%, about 20% to about 30%, about 30% to about 60%, about 30% to about 50%, about 30% to about 40%, about 40% to about 60%, about 40% to about 50%, or about 50% to about 60% of the particulate adsorbent material.

The pore forming material may be present in ≤ about 6%, ≤ about 5%, ≤ about 4%, ≤ about 3%, ≤ about 2%, or ≤ about 1% of the particulate adsorbent material.

The silicate may be present in ≤ about 10%, ≤ about 9%, ≤ about 8%, ≤ about 7%, ≤ about 6%, ≤ about 5%, ≤ about 4%, ≤ about 3%, ≤ about 2%, or ≤ about 1% of the particulate adsorbent material.

The clay may be present in about 5% to about 70%, 5% to about 60%, about 5% to about 50%, about 5% to about 40%, about 5% to about 30%, about 5% to about 20%, about 5% to about 10%, about 10% to about 70%, about 10% to about 60%, about 10% to about 50%, about 10% to about 40%, about 10% to about 30%, about 10% to about 20%, about 20% to about 70%, about 20% to about 60%, about 20% to about 50%, about 20% to about 40%, about 20% to about 30%, about 30% to about 70%, about 30% to about 60%, about 30% to about 50%, about 30% to about 40%, about 40% to about 70%, about 40% to about 60%, about 40% to about 50%, about 50% to about 70%, about 50% to about 60%, or about 60% to about 70% of the particulate adsorbent material.

The pore forming material (or processing aid) produces macroscopic pores when it is sublimated, vaporized, chemically decomposed, solubilized, or melted. This provides a spatial dilution of the adsorbent material. The pore forming material may be a cellulose derivative, such as methylcellulose, carboxymethyl cellulose, polyethylene glycol, phenol-formaldehyde resins (novolac, resole), polyethylene or polyester resins. The cellulose derivative may include copolymers with methyl groups and/or partial substitutions with hydroxypropyl and/or hydroxyethyl groups. The pore forming material or processing aid may sublimate, vaporize, chemically decompose, solubilize, or melt when heated to a temperature in a range of about 125° C. to about 640° C. For example, the processing aid may sublimate, vaporize, chemically decompose, solubilize, or melt when heated to a temperature in a range of about 125° C. to about 600° C., about 125° C. to about 550° C., about 125° C. to about 500° C., about 125° C. to about 450° C., about 125° C. to about 400° C., about 125° C. to about 350° C., about 125° C. to about 300° C., about 125° C. to about 250° C., about 125° C. to about 200° C., about 125° C. to about 150° C., about 150° C. to about 640° C., 150° C. to about 600° C., about 150° C. to about 550° C., about 150° C. to about 500° C., about 150° C. to about 450° C., about 150° C. to about 400° C., about 150° C. to about 350° C., about 150° C. to about 300° C., about 150° C. to about 250° C., about 150° C. to about 200° C., about 200° C. to about 640° C., 200° C. to about 600° C., about 200° C. to about 550° C., about 200° C. to about 500° C., about 200° C. to about 450° C., about 200° C. to about 400° C., about 200° C. to about 350° C., about 200° C. to about 300° C., about 200° C. to about 250° C., about 250° C. to about 640° C., 250° C. to about 600° C., about 250° C. to about 550° C., about 250° C. to about 500° C., about 250° C. to about 450° C., about 250° C. to about 400° C., about 250° C. to about 350° C., about 250° C. to about 300° C., about 300° C. to about 640° C., 300° C. to about 600° C., about 300° C. to about 550° C., about 300° C. to about 500° C., about 300° C. to about 450° C., about 300° C. to about 400° C., about 300° C. to about 350° C., about 350° C. to about 640° C., 350° C. to about 600° C., about 350° C. to about 550° C., about 350° C. to about 500° C., about 350° C. to about 450° C., about 350° C. to about 400° C., about 400° C. to about 640° C., 400° C. to about 600° C., about 400° C. to about 550° C., about 400° C. to about 500° C., about 400° C. to about 450° C., about 450° C. to about 640° C., 450° C. to about 600° C., about 450° C. to about 550° C., about 450° C. to about 500° C., about 500° C. to about 640° C., 500° C. to about 600° C., about 500° C. to about 550° C., about 550° C. to about 640° C., 550° C. to about 600° C., or about 600° C. to about 640° C.

The binder may be a clay or a silicate material. For example, the binder may be at least one of Zeolite clay, Bentonite clay, Montmorillonite clay, Illite clay, French Green clay, Pascalite clay, Redmond clay, Terramin clay, Living clay, Fuller's Earth clay, Ormalite clay, Vitallite clay, Rectorite clay, Cordierite, or a combination thereof.

The filler may function in the particulate adsorbent structure for aiding and preserving shape formation and mechanical integrity, and for enhancing the amount of macropore volume in the final particulate product. In an embodiment, the filler is solid or hollow microspheres, which may be of micron size or larger. In other embodiments, the filler is an inorganic filler, such as a glass material and/or a ceramic material. The filler may be any appropriate filler, which one skilled in the art would appreciate, that provides the above benefits.

In another aspect, the present disclosure provides a method of preparing a particulate adsorbent material. The method comprising: admixing an adsorbent with microscopic pores having a diameter less than about 100 nm and a pore forming material or processing aid that sublimates, vaporizes, chemically decomposes, solubilizes, or melts when heated to a temperature of 100° C. or more; and heating the mixture to a temperature in a range of about 100° C. to about 1200° C. for about 0.25 hours to about 24 hours forms macroscopic pores having a diameter of about 100 nm or greater when the core material is sublimated, vaporized, chemically decomposed, solubilized, or melted, wherein a ratio of a volume of the macroscopic pores to a volume of the microscopic pores in the adsorbent is greater than 150%. The adsorbent may have any of the characteristics of the particulate adsorbent material discussed throughout the present disclosure.

The mixture may be heated to about 100° C. to about 1100° C., about 100° C. to about 1000° C., about 100° C. to about 900° C., about 100° C. to about 800° C., about 100° C. to about 700° C., about 100° C. to about 600° C., about 100° C. to about 500° C., about 100° C. to about 400° C., about 100° C. to about 300° C., about 100° C. to about 200° C., about 200° C. to about 1200° C., about 200° C. to about 1100° C., about 200° C. to about 1000° C., about 200° C. to about 900° C., about 200° C. to about 800° C., about 200° C. to about 700° C., about 200° C. to about 600° C., about 200° C. to about 500° C., about 200° C. to about 400° C., about 200° C. to about 300° C., about 300° C. to about 1200° C., about 300° C. to about 1100° C., about 300° C. to about 1000° C., about 300° C. to about 900° C., about 300° C. to about 800° C., about 300° C. to about 700° C., about 300° C. to about 600° C., about 300° C. to about 500° C., about 300° C. to about 400° C., about 400° C. to about 1200° C., about 400° C. to about 1100° C., about 400° C. to about 1000° C., about 400° C. to about 900° C., about 400° C. to about 800° C., about 400° C. to about 700° C., about 400° C. to about 600° C., about 400° C. to about 500° C., about 500° C. to about 1200° C., about 500° C. to about 1100° C., about 500° C. to about 1000° C., about 500° C. to about 900° C., about 500° C. to about 800° C., about 500° C. to about 700° C., about 500° C. to about 600° C., about 600° C. to about 1200° C., about 600° C. to about 1100° C., about 600° C. to about 1000° C., about 600° C. to about 900° C., about 600° C. to about 800° C., about 600° C. to about 700° C., about 700° C. to about 1200° C., about 700° C. to about 1100° C., about 700° C. to about 1000° C., about 700° C. to about 900° C., about 700° C. to about 800° C., about 800° C. to about 1200° C., about 800° C. to about 1100° C., about 800° C. to about 1000° C., about 800° C. to about 900° C., about 900° C. to about 1200° C., about 900° C. to about 1100° C., about 900° C. to about 1000° C., about 1000° C. to about 1200° C., about 1000° C. to about 1100° C., or about 1100° C. to about 1200° C.

In some embodiments, heating the mixture may include a ramp rate of about 2.5° C./minute (e.g., about 1.0° C./minute, about 1.25° C./minute, about 1.5° C./minute, about 1.75° C./minute, about 2.0° C./minute, about 2.25° C./minute, about 2.75° C./minute, about 3.0° C./minute, about 3.25° C./minute, about 3.5° C./minute, about 3.75° C./minute, about 4.0° C./minute, or 4.25° C./minute). For example, the ramp rate may be about 0.5° C./minute to about 20° C./minute, about 0.5° C./minute to about 15° C./minute, about 0.5° C./minute to about 10° C./minute, about 0.5° C./minute to about 5.0° C./minute, about 0.5° C./minute to about 2.5° C./minute, about 1.0° C./minute to about 20° C./minute, about 1.0° C./minute to about 15° C./minute, about 1.0° C./minute to about 10° C./minute, about 1.0° C./minute to about 5.0° C./minute, about 1.0° C./minute to about 2.5° C./minute, about 2.0° C./minute to about 20° C./minute, about 2.0° C./minute to about 15° C./minute, about 2.0° C./minute to about 10° C./minute, about 2.0° C./minute to about 5.0° C./minute, about 2.0° C./minute to about 2.5° C./minute, about 5.0° C./minute to about 20° C./minute, about 5.0° C./minute to about 15° C./minute, about 5.0° C./minute to about 10° C./minute, about 10° C./minute to about 20° C./minute, about 10° C./minute to about 15° C./minute, or about 15° C./minute to about 20° C./minute. For example, the ramp to the temperature may take about 5 minutes to about 2 hours, about 5 minutes to about 1.75 hours, about 5 minutes to about 1.5 hours, about 5 minutes to about 1.25 hours, about 5 minutes to about 1.0 hours, about 5 minutes to about 45 minutes, about 5 minutes to about 30 minutes, about 5 minutes to about 15 minutes, about 15 minutes to about 2 hours, about 15 minutes to about 1.75 hours, about 15 minutes to about 1.5 hours, about 15 minutes to about 1.25 hours, about 15 minutes to about 1.0 hours, about 15 minutes to about 45 minutes, about 15 minutes to about 30 minutes, about 30 minutes to about 2 hours, about 30 minutes to about 1.75 hours, about 30 minutes to about 1.5 hours, about 30 minutes to about 1.25 hours, about 30 minutes to about 1.0 hours, about 30 minutes to about 45 minutes, about 45 minutes to about 2 hours, about 45 minutes to about 1.75 hours, about 45 minutes to about 1.5 hours, about 45 minutes to about 1.25 hours, about 45 minutes to about 1.0 hours, about 1.0 hours to about 2 hours, about 1.0 hours to about 1.75 hours, about 1.0 hours to about 1.5 hours, about 1.0 to about 1.25 hours, about 1.25 to about 2 hours, about 1.25 to about 1.75 hours, about 1.25 to about 1.5 hours, about 1.5 to about 2 hours, about 1.5 to about 1.75 hours, or about 1.75 hours to about 2.0 hours.

In another embodiment, the mixture is held at the temperature (i.e., after the ramp) for about 0.25 hours to about 24 hours. For example, the mixture may be held at the temperature for about 0.25 hours to about 18 hours, about 0.25 hours to about 16 hours, about 0.25 hours to about 14 hours, about 0.25 hours to about 12 hours, about 0.25 hours to about 10 hours, about 0.25 hours to about 8 hours, about 0.25 hours to about 6 hours, about 0.25 hours to about 4 hours, about 0.25 hours to about 2 hours, about 1 hour to about 24 hours, about 0.25 hours to about 18 hours, about 1 hour to about 16 hours, about 1 hour to about 14 hours, about 1 hour to about 12 hours, about 1 hour to about 10 hours, about 1 hour to about 8 hours, about 1 hour to about 6 hours, about 1 hour to about 4 hours, about 1 hour to about 2 hours, about 2 hours to about 24 hours, about 2 hours to about 18 hours, about 2 hours to about 16 hours, about 2 hours to about 14 hours, about 2 hours to about 12 hours, about 2 hours to about 10 hours, about 2 hours to about 8 hours, about 2 hours to about 6 hours, about 2 hours to about 3 hours, about 3 hours to about 24 hours, about 3 hours to about 18 hours, about 3 hours to about 16 hours, about 3 hours to about 14 hours, about 3 hours to about 12 hours, about 3 hours to about 10 hours, about 3 hours to about 8 hours, about 3 hours to about 6 hours, about 3 hours to about 4 hours, about 4 hours to about 24 hours, about 4 hours to about 18 hours, about 4 hours to about 16 hours, about 4 hours to about 14 hours, about 4 hours to about 12 hours, about 4 hours to about 10 hours, about 4 hours to about 8 hours, about 4 hours to about 6 hours, about 6 hours to about 24 hours, about 6 hours to about 18 hours, about 6 hours to about 16 hours, about 6 hours to about 14 hours, about 6 hours to about 12 hours, about 6 hours to about 10 hours, about 6 hours to about 8 hours, about 8 hours to about 24 hours, about 8 hours to about 18 hours, about 8 hours to about 16 hours, about 8 hours to about 14 hours, about 8 hours to about 12 hours, about 8 hours to about 10 hours, about 10 hours to about 24 hours, about 10 hours to about 18 hours, about 10 hours to about 16 hours, about 10 hours to about 14 hours, about 10 hours to about 12 hours, about 12 hours to about 24 hours, about 12 hours to about 18 hours, about 12 hours to about 16 hours, about 12 hours to about 14 hours, about 14 hours to about 24 hours, about 14 hours to about 18 hours, about 14 hours to about 16 hours, about 16 hours to about 24 hours, about 16 hours to about 18 hours, about 18 hours to about 24 hours, about 18 hours to about 22 hours, about 18 hours to about 20 hours, about 20 hours to about 24 hours, about 20 hours to about 22 hours, or about 22 hours to about 24 hours.

The method may further comprise cooling the mixture (e.g., to about room temperature). In an embodiment, the mixture may be cooled over about 4 to about 10 hours. For example, the mixture may be cooled over about 4 hours to about 9 hours, about 4 hours to about 8 hours, about 4 hours to about 7 hours, about 4 hours to about 6 hours, about 4 hours to about 5 hours, about 5 hours to about 10 hours, about 5 hours to about 9 hours, about 5 hours to about 8 hours, about 5 hours to about 7 hours, about 5 hours to about 6 hours, about 6 hours to about 10 hours, about 6 hours to about 9 hours, about 6 hours to about 8 hours, about 6 hours to about 7 hours, about 7 hours to about 10 hours, about 7 hours to about 9 hours, about 7 hours to about 8 hours, about 8 hours to about 10 hours, about 8 hours to about 9 hours, or about 9 hours to about 10 hours.

In a further embodiment, the heating of the mixture is performed in an inert atmosphere (e.g., nitrogen, argon, neon, krypton, xenon, radon, flue gas wherein the steam and oxygen content are controlled, or a combination thereof).

The particulate adsorbent material may have a retentivity of about 1.0 g/dL or less, about 0.75 g/dL or less, about 0.50 g/dL or less, or about 0.25 g/dL or less. For example, the adsorbent may have a retentivity of about 0.25 g/dL to about 1.00 g/dL, about 0.25 g/dL to about 0.75 g/dL, about 0.25 g/dL to about 0.50 g/dL, about 0.50 g/dL to about 1.00 g/dL, about 0.50 g/dL to about 0.75 g/dL, or about 0.75 g/dL to about 1.00 g/dL.

In any aspect or embodiment described herein, at least one of the diameter of the microscopic pores is about 2 nm to less than about 100 nm, the diameter of the macroscopic pores is equal to or greater than 100 nm and less than 100,000 nm, or a combination thereof.

The method may further comprise extruding or compressing the admix into a shaped structure. For example, the extruded or compressed particulate adsorbent material may comprise a body defining an exterior surface and a three-dimensional low flow resistant shape or morphology. The low flow resistant shape or morphology can be, e.g., any shape or morphology described herein for the adsorbent material. For example, the three-dimensional low flow resistant shape or morphology may be at least one of substantially a cylinder, substantially an oval prism, substantially a sphere, substantially a cube, substantially an elliptical prism, substantially a rectangular prism, a lobed prism, a three-dimensional spiral, the shape or morphology illustrated in FIGS. 1A through 1I, or a combination thereof.

The adsorbent may be at least one of activated carbon, molecular sieves, porous alumina, clay, porous silica, zeolites, metal organic frameworks, or a combination thereof.

The mixture may further comprise a binder (such as clay, silicate or a combination thereof), and/or a filler. The filler may be any filler known or that becomes known in the relevant art.

The adsorbent may have a cross-sectional width as described here, such as in a range of about 1 mm to about 20 mm.

The particulate adsorbent material may include at least one cavity or channel in fluid communication with an exterior surface of the adsorbent. The particulate adsorbent may have a hollow shape in cross section. Each part of the adsorbent may have a thickness of about 3.0 mm or less. An exterior wall of the hollow shape may have a thickness that is 3 mm or less (e.g., about 0.1 mm to about 1.0 mm). The hollow shape may have interior walls extending between the exterior walls, which may have, e.g., a thickness of about 3.0 mm or less (e.g., about 0.1 mm to about 1.0 mm).

The interior walls may extend outward to the exterior wall in at least two directions, at least three directs, or at least four directions from the interior volume (such as, from the hollow portion), such as a center.

In some embodiments, the adsorbent has a length of about 1 mm to about 20 mm (e.g., about 2 mm to about 7 mm).

In a further aspect, the present disclosure provides for a particulate adsorbent material produced by the method of the present disclosure.

### Examples

Test Methods.

The standard method ASTM D 2854-09 (2014) (hereinafter “the Standard Method”) may be used to determine the apparent density of particulate adsorbents, taking into account the prescribed minimum ratio of 10 for the measuring cylinder diameter to mean particle diameter of the particulate material, with mean particle diameter measured according to the prescribed standard screening method.

The standard method ASTM D5228-16 may be used to determine the butane working capacity (BWC) of the adsorbent volumes containing particulate granular and/or pelletized adsorbents. The retentivity (g/dL) is calculated as the difference between the volumetric butane activity (g/dL) [i.e., the weight-basis saturation butane activity (g/100 g) multiplied by the apparent density (g/cc)] and the BWC (g/dL).

Macroscopic pore volume is measured by mercury intrusion porosimetry method ISO 15901-1:2016. The equipment used for the examples was a Micromeritics Autopore V (Norcross, Ga.). Samples used were around 0.4 g in size and pre-treated for at least 1 hour in an oven at 105° C. The surface tension of mercury and contact angle used for the Washburn equation were 485 dynes/cm and 130°, respectively.

Microscopic pore volume is measured by nitrogen adsorption porosimetry by the nitrogen gas adsorption method ISO 15901-2:2006 using a Micromeritics ASAP 2420 (Norcross, Ga.). The sample preparation procedure was to degas to a pressure of less than 10 μmHg. The determination of pore volumes are for the microscopic pore sizes was from the desorption branch of the 77 K isotherm for a 0.1 g sample. The nitrogen adsorption isotherm data was analyzed by the Kelvin and Halsey equations to determine the distribution of pore volume with pore size of cylindrical pores according to the model of Barrett, Joyner, and Halenda (“BJH”). The non-ideality factor was 0.0000620. The density conversion factor was 0.0015468. The thermal transpiration hard-sphere diameter was 3.860 Å. The molecular cross-sectional area was 0.162 nm². The condensed layer thickness (Å) related to pore diameter (D, Å) used for the calculations was 0.4977 [ln(D)]²−0.6981 ln(D)+2.5074. Target relative pressures for the isotherm were the following: 0.04, 0.05, 0.085, 0.125, 0.15, 0.18, 0.2, 0.355, 0.5, 0.63, 0.77, 0.9, 0.95, 0.995, 0.95, 0.9, 0.8, 0.7, 0.6, 0.5, 0.45, 0.4, 0.35, 0.3, 0.25, 0.2, 0.15, 0.12, 0.1, 0.07, 0.05, 0.03, 0.01. Actual points were recorded within an absolute or relative pressure tolerance of 5 mmHg or 5%, respectively, whichever was more stringent. Time between successive pressure readings during equilibration was 10 seconds.

The flow restriction was measured as pressure drop (Pa/cm) for different shaped adsorbent particles across a 30 mm length of dense-packed bed at a given standard liter per minute (SLPM) with the device shown in FIG. 4. In particular, the pressure drop (Pa/cm) was measured across a 30 mm depth at the center of a pellet bed with 43 mm diameter for an air flow range of 10-70 SLPM (24-165 cm/s). Adsorbent was loaded into a 43 mm inner diameter tube with ports drilled +/−15 mm as measured from the midpoint along the bed depth. Open cell foam was used to contain the carbon bed. For the pressure purge, compressed air was loaded through port 1 to atmosphere on port 2; the pressure drop across ports 3 and 4 was measured. For the vacuum purge, a vacuum was pulled through port 1; the pressure drop was measured across ports 3 and 4. The flow was adjusted from 10-70 SLPM (24-165 cm/s) and pressure drop measured at each adjustment.

The strength of the adsorbent particles of the present disclosure was examined using the art-acceptable variation of the standard ASTM 3802-79 method. The method is detailed in U.S. Pat. No. 6,573,212 as an abrasion hardness test, reporting the result as pellet strength. As noted in U.S. Pat. No. 5,324,703, this industry standard test has a typical minimum acceptable strength of 55.

Making the Particulate Adsorbent Material.

Exemplary particulate adsorbent material was produced by mixing Nuchar® activated carbon powder, kaolin clay, nepheline syenite (a mineral ingredient added to clay), calcined kaolin (clay), methylcellulose, sodium silicate, and hollow borosilicate glass microspheres, as described below. The general compositions of the exemplary particulate adsorbent material (E-1 through E-6) and comparative examples (C-1 through C-14) are shown in Table 1 and Table 2 with C-14 being a commercially obtained product. In particular, the adsorbent was obtained from commercially purchased Honda Civic emission control canisters. One skilled in the art would appreciate that many variations to the formulation will result in the production of particulate adsorbent material of the present disclosure.

TABLE 1
General composition of exemplary particulate adsorbent material.

| | | | | Glass | |
|---|---|---|---|---|---|
| | | Carbon | Clay Binder | Microspheres | Cellulose |
| ID | Shape | (%) | (%) | (%) | Derivative (%) |
| E-1 | FIG. 1C | 5.0% | 50.6% | 40.0% | 4.4% |
| E-2 | FIG. 1C | 5.0% | 69.6% | 21.0% | 4.4% |
| E-3 | FIG. 1C | 18.4% | 47.5% | 29.7% | 4.4% |
| E-4 | FIG. 1C | 18.4% | 47.5% | 29.7% | 4.4% |
| E-5 | FIG. 1C | 35.6% | 20.0% | 40.0% | 4.4% |
| E-6 | FIG. 1C | 24.0% | 40.6% | 31.0% | 4.4% |
| C-1 | FIG. 1C | 25.0% | 40.6% | 30.0% | 4.4% |
| C-2 | FIG. 1C | 31.9% | 44.3% | 19.4% | 4.4% |
| C-3 | FIG. 1C | 31.9% | 44.3% | 19.4% | 4.4% |
| C-4 | FIG. 1C | 24.0% | 51.6% | 20.0% | 4.4% |
| C-5 | FIG. 1C | 28.7% | 57.2% | 9.7% | 4.4% |
| C-6 | FIG. 1C | 60.0% | 20.0% | 15.6% | 4.4% |
| C-7 | FIG. 1C | 45.9% | 32.2% | 17.5% | 4.4% |
| C-8 | FIG. 1C | 28.6% | 67.0% | 0.0% | 4.4% |
| C-9 | FIG. 1C | 8.0% | 87.6% | 0.0% | 4.4% |
| C-10 | FIG. 1C | 28.6% | 67.0% | 0.0% | 4.4% |
| C-11 | FIG. 1C | 30.0% | 65.6% | 0.0% | 4.4% |
| C-12 | FIG. 1C | 60.0% | 35.6% | 0.0% | 4.4% |
| C-13 | FIG. 1C | 25.6% | 70.0% | 0.0% | 4.4% |
| C-14 | FIG. 1C | — | — | — | — |

TABLE 2
Composition of example E-3

| | Content | Dry wt | Moist, | Wet wt | H₂O |
|---|---|---|---|---|---|
| Example E-3 | (db), % | (g) | % | (g) | wt (g) |
| Carbon powder | 18.4% | 828.0 | 2.73% | 851.2 | 23.2 |
| Methylcellulose | 4.4% | 198.0 | 5.71% | 210 | 12 |
| Kaolin | 36.3% | 1633.5 | 2.83% | 1681.1 | 47.6 |
| Calcined kaolin | 1.8% | 81.7 | 3.53% | 84.7 | 3.0 |
| Nepheline syenite | 7.3% | 326.7 | 0.51% | 328.4 | 1.7 |
| Glass microspheres | 29.7% | 1336.5 | 5.00% | 1406.8 | 70.3 |
| Sodium silicate | 2.1% | 96.4 | 51.00% | 1.96.7 | 100.3 |
| Batch Size (g,db) | 100.0% | 4500.0 | | 4660.3 | 258.2 |
| Green mix moisture | | | | | 35.3% |
| Total moisture, g | | | | | 2458 |
| Water addition, g | | | | | 2200 |
| Water addition, ml | | | | | 2200.0 |
| “Clay” | 47.5% | | | | |

The ingredients of the particulate adsorbent material were mixed in the amounts described above in a mixer. The dry ingredients were charged to the equipment and then the silicate and a sufficient amount of water were added to result in an extrudable paste. Numerous types of mixers can be utilized to achieve the uniform distribution of ingredients and the high shear mixing necessary to develop a paste with appropriate rheology for extrusion. One skilled in the art would appreciate that numerous types of extruders would be effective for the mixture of the disclosure to produce the particulate adsorbent material of the present disclosure.

The extrusion dies consisted of a multi-hole plate with inserts that direct material flow to create hollow pellets. The majority of the examples used cylindrical tubes with a shaped support in the middle, as shown in FIG. 1C, but any multitude of low flow restriction shapes are contemplated by the present disclosure. The outer diameter of the extrudate was 5.0 mm and the outer wall and supports had a wall thickness of 0.75 mm. Hollow composite lobe shapes (see FIG. 1A), hollow rectangular prism shapes (see FIG. 1B), and hollow triangular prism shapes (see FIG. 1G), with similar nominal outer dimensions (i.e., about 4-7 mm outer diameters and about 0.5-1.0 mm thick walls) demonstrated similar test results (data now shown). In ascribing a nominal outer diameter (i.e., cross-sectional width), examples are shown in FIGS. 1A through 1I as “d”: the side width of a square cross-section (FIG. 1B), the noted widths for a composite lobed (FIG. 1A), a star shape (FIG. 1D), a cross or ‘X’ shape (FIG. 1E), and triangular shape (FIGS. 1F and 1G) cross-section, and for the twisted ribbon in a helical shape (FIG. 1H1 with the width shown in FIG. 1H2).

The extrudates were cut with a rotary cutter to a target length of about 5 mm or about 10 mm and then dried on trays placed in a convection oven at about 110° C. overnight. However, the particles may be dried on a forced air belt dryer, in a rotary kiln, or by the use of any furnace with sufficient air flow and low humidity to dry the pellets.

The dried particles/pellets were then calcined under inert nitrogen atmosphere in a box furnace, a tube furnace, or in a rotary kiln. Most samples were prepared with about 2.5° C./min ramp rate up to about 1100° C. with an about 3 hour hold at maximum temperature, followed by cooling to room temperature over about 6-8 hours. A variety of calcination conditions appear to be suitable. Ramp times as fast as about 10 minutes have been investigated with hold-times as short as 20 minutes. Temperatures in excess of 900° C. seem to ensure good pellet strength, but are not required. Any inert atmosphere can be utilized (such as, nitrogen, argon, or possibly flue gas as long as steam and oxygen content are controlled). The inventors have successfully produced good product using a nitrogen atmosphere in a rotary kiln at about 970° C. with a residence time of 30 minutes.

Examination of Retentivity of Adsorbent Particles.

By varying the proportions of ingredients, exemplary particulate adsorbent material was prepared with a range of porosity properties, with the ratio of a volume of macroscopic pores of about 100 nm or greater to a volume of microscopic pores of less than 100 nm ranging from about 47% to about 1333%. The data can be found in FIG. 2 and Table 3. It was surprising and unexpectedly observed that adsorbent particles with a ratio greater than 150% had significantly lower retentivity (e.g., 0.48 g/dL at 190% ratio for Example E-5 and 0.34 g/dL at 241% for Example E-3) relative to those comparative examples with a ratio less than 150%, such as commercially available comparative example C-14. This benefit to retentivity is in stark contrast to the trend taught by U.S. Pat. No. 9,174,195, where retentivity between ratios of 65% and 150% was asymptotic to above 1 g/dL and the example at a ratio above 150% was above the cited 1.7 g/dL target.

Examination of Adsorbent Particle Strength.

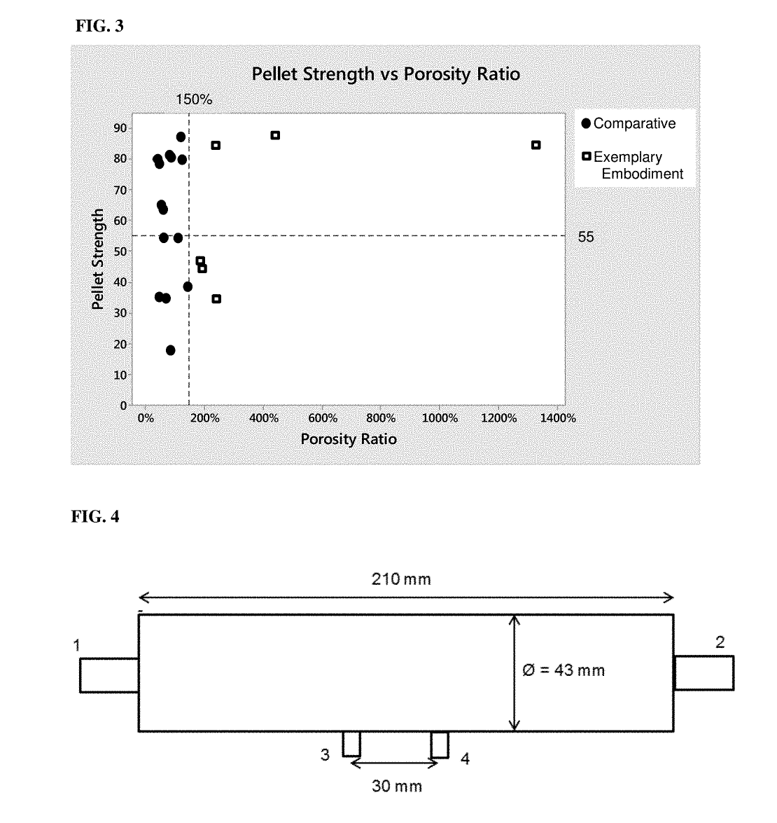

The data is shown in Table 3 and FIG. 3. It was surprisingly discovered that adsorbent particles with a ratio of a volume of macroscopic pores of about 100 nm or greater to a volume of microscopic pores of less than 100 nm greater than 150% have significant pellet strength that was independent of pore ratio, as shown in FIG. 3. In contrast, U.S. Pat. No. 9,174,195 demonstrated that adsorbent material strength sharply declined when the above ratio is 150% or greater (see, e.g., C-14).

TABLE 3
Characteristics of adsorbent compositions

| | | | Butane | | | | | |
|---|---|---|---|---|---|---|---|---|
| | Apparent | Butane | Working | | | | Pore | |
| | Density | Activity | Capacity | Retentivity | Hg | BJH | Volume | Pellet |
| ID | (g/mL) | (g/100 g) | (g/dL) | (g/dL) | (0.1-100 um) | (<0.1 um) | Ratio | Strength |
| E-1 | 0.409 | 2.01 | 0.82 | 0.01 | 0.559 | 0.042 | 1330% | 85 |
| E-2 | 0.551 | 2.21 | 1.11 | 0.11 | 0.240 | 0.054 | 441% | 88 |
| E-3 | 0.401 | 7.52 | 2.67 | 0.34 | 0.486 | 0.201 | 241% | 35 |
| E-4 | 0.375 | 7.29 | 2.45 | 0.29 | 0.481 | 0.205 | 235% | 85 |
| E-5 | 0.252 | 14.52 | 3.18 | 0.48 | 0.760 | 0.399 | 190% | 45 |
| E-6 | 0.361 | 10.65 | 3.36 | 0.48 | 0.494 | 0.268 | 184% | 47 |
| C-1 | 0.364 | 11.39 | 3.60 | 0.55 | 0.434 | 0.301 | 144% | 39 |
| C-2 | 0.360 | 13.53 | 3.99 | 0.89 | 0.456 | 0.362 | 126% | 80 |
| C-3 | 0.345 | 13.64 | 3.88 | 0.82 | 0.422 | 0.355 | 119% | 88 |
| C-4 | 0.418 | 10.85 | 3.93 | 0.61 | 0.296 | 0.271 | 109% | 54 |
| C-5 | 0.433 | 12.57 | 4.43 | 1.01 | 0.306 | 0.344 | 89% | 81 |
| C-6 | 0.258 | 25.71 | 5.36 | 1.27 | 0.583 | 0.686 | 85% | 18 |
| C-7 | 0.309 | 19.85 | 4.95 | 1.18 | 0.449 | 0.532 | 84% | 81 |
| C-8 | 0.503 | 12.37 | 5.07 | 1.15 | 0.190 | 0.328 | 58% | 55 |
| C-9 | 0.765 | 3.34 | 2.17 | 0.39 | 0.057 | 0.101 | 56% | 64 |
| C-10 | 0.520 | 12.32 | 5.18 | 1.22 | 0.184 | 0.340 | 54% | 65 |
| C-11 | 0.501 | 12.67 | 5.12 | 1.23 | 0.167 | 0.349 | 48% | 79 |
| C-12 | 0.320 | 25.71 | 6.26 | 1.96 | 0.334 | 0.711 | 47% | 35 |
| C-13 | 0.519 | 11.44 | 4.80 | 1.14 | 0.111 | 0.312 | 35% | 80 |
| C-14 | 0.336 | 26.52 | 7.92 | 0.98 | 0.415 | 0.595 | 70% | 35 |

Examination of the Pressure Drop of Adsorbent Particles.

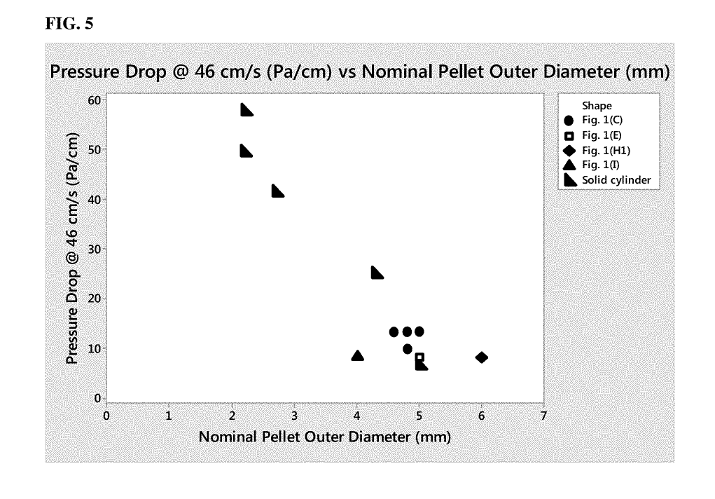

Table 4 and FIG. 5 show the flow restriction properties of alternative shaped adsorbent materials in terms of the pressure drop between two points within a packed bed of particulate material. What became apparent to the inventors is that the properties were driven strongly by the nominal outer diameter dimensions as a primary effect, compared with the “hollowness” of the shape. Therefore, one skilled in the art would strive to understand the nominal outer diameter effects of a selected shape for tuning the flow restriction properties (convective requirements). One skilled in the art would then adjust the hollow cell size, cell volume, and thinness of the walls for tuning the desired amount of wall material for working capacity and strength in balance with adsorbate access for adsorption and desorption properties. For a helical or spiral shape without a defined cell, the adjustments would be to the ribbon width and pitch of the twist for flow restriction, thickness of the ribbon for strength and adsorption and desorption properties, and the pitch and thickness for working capacity.

TABLE 4
Pressure drop data for adsorbent particles

| | | Nominal Pellet | Pressure Drop |
|---|---|---|---|
| ID | Shape | Outer Diameter (mm) | @ 46 cm/s (Pa/cm) |
| E-7 | FIG. 1(C) | 5.0 | 13 |
| E-8 | FIG. 1C | 4.8 | 10 |
| E-9 | FIG. 1C | 4.8 | 13 |
| C-15 | FIG. 1C | 4.6 | 13 |
| C-16 | Solid | 2.2 | 50 |
| | cylinder | | |
| C-17 | Solid | 2.2 | 58 |
| | cylinder | | |
| C-18 | Solid | 2.7 | 42 |
| | cylinder | | |
| C-19 | FIG. 1H1 | 6.0 | 8 |
| C-20 | FIG. 1E | 5.0 | 8 |
| C-21 | Solid | 4.3 | 25 |
| | cylinder | | |
| C-22 | Solid | 5.0 | 7 |
| | cylinder | | |
| C-23 | FIG. 1I | 4.0 | 8 |

### Specific Embodiments

In an aspect, the present disclosure provides a particulate adsorbent material, which may be used for evaporative emission control. The material comprises: an adsorbent having microscopic pores with a diameter of less than about 100 nm; macroscopic pores having a diameter of about 100 nm or greater; and a ratio of a volume of the macroscopic pores to a volume of the microscopic pores is greater than about 150%, wherein particulate adsorbent material has a retentivity of about 1.0 g/dL or less.

In any aspect or embodiments described herein, the particulate adsorbent material has a retentivity of about 0.75 g/dL or less.

In any aspect or embodiments described herein, the particulate adsorbent material has a retentivity of about 0.25 to about 1.00 g/dL.

In any aspect or embodiments described herein, the particulate adsorbent material is at least one of activated carbon, carbon charcoal, molecular sieves, porous polymers, porous alumina, clay, porous silica, kaolin, zeolites, metal organic frameworks, titania, ceria, or a combination thereof.

In any aspect or embodiments described herein, the particulate adsorbent material has a micropore volume (determined by, e.g., BJH) of about 0.5 cc/g or less (about 225 cc/L or less).

In any aspect or embodiments described herein, the particulate adsorbent material comprises a body defining an exterior surface and a three-dimensional low flow resistance shape or morphology.

In any aspect or embodiments described herein, the three-dimensional low flow resistance shape or morphology is at least one of substantially a cylinder, substantially an oval prism, substantially a sphere, substantially a cube, substantially an elliptical prism, substantially a rectangular prism, a trilobe prism, a three-dimensional spiral, or a combination thereof.

In any aspect or embodiments described herein, the particulate adsorbent material has a cross-sectional width of about 1 mm to about 20 mm.

In any aspect or embodiments described herein, the cross-sectional width is about 3 mm to about 7 mm.

In any aspect or embodiments described herein, the particulate adsorbent material has a hollow shape in cross section.

In any aspect or embodiments described herein, the particulate adsorbent material includes at least one cavity in fluid communication with the exterior surface of the adsorbent.

In any aspect or embodiments described herein, each part of the particulate adsorbent material has a thickness of about 0.1 mm to about 3.0 mm.

In any aspect or embodiments described herein, at least one exterior wall of the hollow shape has a thickness in a range of about 0.1 mm to about 1.0 mm.

In any aspect or embodiments described herein, the hollow shape has at least one interior wall extending between the exterior walls and having a thickness in a range of about 0.1 mm to about 1.0 mm.

In any aspect or embodiments described herein, the thickness of at least one of the interior wall, the exterior wall or a combination thereof is about 0.3 mm to about 0.8 mm.

In any aspect or embodiments described herein, the thickness of at least one of the interior wall, the exterior wall or a combination thereof is about 0.4 mm to about 0.7 mm.

In any aspect or embodiments described herein, the interior wall extends outward to the exterior wall in at least two directions from a hollow portion of the particulate adsorbent material (such as, from a center of the particulate adsorbent material).

In any aspect or embodiments described herein, the interior walls extends outward to the exterior wall in at least three directions from a hollow portion of the particulate adsorbent material (such as, from a center of the particulate adsorbent material).

In any aspect or embodiments described herein, the interior walls extends outward to the exterior wall in at least four directions from a hollow portion of the particulate adsorbent material (e.g., a center of the particulate adsorbent material).

In any aspect or embodiments described herein, the particulate adsorbent material has a length of about 1 mm to about 20 mm.

In any aspect or embodiments described herein, the length is about 2 mm to about 15 mm.

In any aspect or embodiments described herein, the length is about 3 mm to about 8 mm.

In any aspect or embodiments described herein, the activated carbon is derived from at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, synthetic polymer, natural polymer, lignocellulosic material, and combinations thereof

In any aspect or embodiments described herein, the clay is at least one of Zeolite clay, Bentonite clay, Montmorillonite clay, Illite clay, French Green clay, Pascalite clay, Redmond clay, Terramin clay, Living clay, Fuller's Earth clay, Ormalite clay, Vitallite clay, Rectorite clay, or a combination thereof.

In any aspect or embodiments described herein, the particulate adsorbent material further comprises at least one of: a pore forming material or processing aid that decomposes, solubilizes, sublimates, vaporizes, or melts when heated to a temperature of 100° C. or more; a binder; a filler; or a combination thereof.

In any aspect or embodiments described herein, the pore forming material or processing aid is a cellulose derivative.

In any aspect or embodiments described herein, the pore forming material or processing aid is methylcellulose.

In any aspect or embodiments described herein, the pore forming material or processing aid sublimates, vaporizes, chemically decomposes, solubilizes or melts when heated to a temperature in a range of about 125° C. to about 640° C.

In any aspect or embodiments described herein, the binder is clay or a silicate material.

In any aspect or embodiments described herein, the clay is at least one of Zeolite clay, Bentonite clay, Montmorillonite clay, Illite clay, French Green clay, Pascalite clay, Redmond clay, Terramin clay, Living clay, Fuller's Earth clay, Ormalite clay, Vitallite clay, Rectorite clay, or a combination thereof.

In any aspect or embodiments described herein, a packed bed of the particulate adsorbent material has a pressure drop that is <40 Pa/cm at 46 cm/s apparent linear air flow velocity.

In a further aspect, the present disclosure provides, a method of preparing a particulate adsorbent of the present disclosure. The method comprises: admixing an adsorbent with microscopic pores having a diameter less than about 100 nm and a pore forming material or processing aid that sublimates, vaporizes, chemically decomposes, solubilizes, or melts when heated to a temperature of 100° C. or more; and heating the mixture to a temperature in a range of about 100° C. to about 1200° C. for about 0.25 hours to about 24 hours forming macroscopic pores having a diameter of about 100 nm or greater when the core material is sublimated, vaporized, chemically decomposed, solubilized, or melted, wherein the particulate adsorbent has a ratio of a volume of the macroscopic pores to a volume of the microscopic pores that is greater than 150%.

In any aspect or embodiments described herein, the method further comprises extruding or compressing the admix into a shaped structure.

In any aspect or embodiments described herein, the adsorbent is at least one of activated carbon, molecular sieves, porous alumina, clay, porous silica, zeolites, metal organic frameworks, or a combination thereof.

In any aspect or embodiments described herein, the mixture further comprises a binder.

In any aspect or embodiments described herein, the binder is at least one of clay, silicate or a combination thereof.

In any aspect or embodiments described herein, the mixture further comprises a filler.

In any aspect or embodiments described herein, the particulate adsorbent has a cross-sectional width in a range of about 1 mm to about 20 mm.

In any aspect or embodiments described herein, the particulate adsorbent comprises a body defining an exterior surface and a three-dimensional low flow resistant shape or morphology.

In any aspect or embodiments described herein, the three-dimensional low flow resistant shape or morphology is at least one of substantially a cylinder, substantially an oval prism, substantially a sphere, substantially a cube, substantially an elliptical prism, substantially a rectangular prism, a lobed prism, a three-dimensional helix or spiral, or a combination thereof.

In any aspect or embodiments described herein, the particulate adsorbent includes at least one cavity or channel in fluid communication with an exterior surface of the particulate adsorbent.

In any aspect or embodiments described herein, the particulate adsorbent has a hollow shape in cross section.

In any aspect or embodiments described herein, each part of the particulate adsorbent has a thickness of about 0.1 mm to about 3.0 mm.

In any aspect or embodiments described herein, an exterior wall of the hollow shape has a thickness in a range of about 0.1 mm to about 1.0 mm.

In any aspect or embodiments described herein, the hollow shape has at least one interior wall extending between the exterior walls.

In any aspect or embodiments described herein, the interior walls have a thickness in a range of about 0.1 mm to about 1.0 mm.

In any aspect or embodiments described herein, at least one of the interior walls, at least one of the exterior wall, or a combination thereof is about 0.1 mm to about 0.8 mm.

In any aspect or embodiments described herein, the interior walls extend outward to the exterior wall in at least two directions from the interior volume, such as a center.

In any aspect or embodiments described herein, the interior walls extend outward to the exterior wall in at least three directions from the interior volume, such as a center.

In any aspect or embodiments described herein, the interior wall extends outward to the exterior wall in at least four directions from the interior volume, such as a center.

In any aspect or embodiments described herein, the particulate adsorbent has a length of about 1 mm to about 20 mm.

In any aspect or embodiments described herein, the length of the particulate adsorbent is in a range of about 2 mm to about 8 mm.

In any aspect or embodiments described herein, the particulate adsorbent has a retentivity of about 1.0 g/dL or less.

In another aspect, the present disclosure provides a particulate adsorbent material produced by the method of the present disclosure (i.e., the method of preparing a particulate adsorbent of the present disclosure).

While several embodiments of the disclosure have been shown and described herein, it will be understood that such embodiments are provided by way of example only. Numerous variations, changes and substitutions will occur to those skilled in the art without departing from the spirit of the disclosure. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the disclosure.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A particulate adsorbent material for evaporative emission control, the material comprising:
an adsorbent having microscopic pores with a diameter of less than about 100 nm;
macroscopic pores having a diameter of about 100 nm or greater; and
a ratio of a volume of the macroscopic pores to a volume of the microscopic pores is greater than about 150%,
wherein the particulate adsorbent material has a retentivity of about 1.0 g/dL or less.

2. The particulate adsorbent material of claim 1, wherein the adsorbent has a retentivity of about 0.75 g/dL or less.

3. The particulate adsorbent material of claim 1, wherein the adsorbent has a retentivity of about 0.25 to about 1.00 g/dL.

4. The particulate adsorbent material of claim 1, wherein the adsorbent is at least one of activated carbon, carbon charcoal, molecular sieves, porous polymers, porous alumina, clay, porous silica, kaolin, zeolites, metal organic frameworks, titania, ceria, or a combination thereof.

5. The particulate adsorbent material of claim 1, wherein the adsorbent has a micropore volume (determined by, e.g., BJH) of about 0.5 cc/g or less (about 225 cc/L or less).

6. The particulate adsorbent material of claim 1, wherein the adsorbent comprises a body defining an exterior surface and a three-dimensional low flow resistance shape or morphology.

7. The particulate adsorbent material of claim 6, wherein the three-dimensional low flow resistance shape or morphology is at least one of substantially a cylinder, substantially an oval prism, substantially a sphere, substantially a cube, substantially an elliptical prism, substantially a rectangular prism, a trilobe prism, a three-dimensional spiral, or a combination thereof.

8. The particulate adsorbent material of claim 1, wherein the particulate adsorbent material has a cross-sectional width of about 1 mm to about 20 mm.

9. The particulate adsorbent material of claim 1, wherein the adsorbent has a hollow shape in cross section.

10. The particulate adsorbent material of claim 1, wherein the adsorbent includes at least one cavity in fluid communication with the exterior surface of the adsorbent.

11. The particulate adsorbent material of claim 1, wherein each part of the adsorbent has a thickness of about 0.1 mm to about 3.0 mm.

12. The particulate adsorbent material of claim 1, wherein at least one of:
at least one exterior wall of the hollow shape has a thickness in a range of about 0.1 mm to about 1.0 mm;
the hollow shape has at least one interior wall extending between the exterior walls and having a thickness in a range of about 0.1 mm to about 1.0 mm; and
a combination thereof.

13. The particulate adsorbent material of claim 13, wherein the thickness of at least one of the interior wall, the exterior wall or a combination thereof is about 0.3 mm to about 0.8 mm.

14. The particulate adsorbent material of claim 13, wherein the thickness of at least one of the interior wall, the exterior wall or a combination thereof is about 0.4 mm to about 0.7 mm.

15. The particulate adsorbent material of claim 13, wherein the interior wall extends outward to the exterior wall in at least two directions from a hollow portion of the particulate adsorbent material (such as, from a center of the particulate adsorbent material).

16. The particulate adsorbent material of claim 13, wherein the interior walls extends outward to the exterior wall in at least three directions from a hollow portion of the particulate adsorbent material (such as, from a center of the particulate adsorbent material).

17. The particulate adsorbent material of claim 13, wherein the interior walls extends outward to the exterior wall in at least four directions from a hollow portion of the particulate adsorbent material (e.g., a center of the particulate adsorbent material).

18. The particulate adsorbent material of claim 1, wherein the adsorbent has a length of about 1 mm to about 20 mm.

19. The particulate adsorbent material of claim 4, wherein the activated carbon is derived from at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables, synthetic polymer, natural polymer, lignocellulosic material, and combinations thereof.

20. The particulate adsorbent material of claim 4, wherein the clay is at least one of Zeolite clay, Bentonite clay, Montmorillonite clay, Illite clay, French Green clay, Pascalite clay, Redmond clay, Terramin clay, Living clay, Fuller's Earth clay, Ormalite clay, Vitallite clay, Rectorite clay, or a combination thereof.

21. The particulate adsorbent material of claim 1, further comprises at least one of:
a pore forming material or processing aid that decomposes, solubilizes, sublimates, vaporizes, or melts when heated to a temperature of 100° C. or more;
a binder;
a filler; or
a combination thereof.

22. The particulate adsorbent material of claim 21, wherein the pore forming material or processing aid is a cellulose derivative.

23. The particulate adsorbent material of claim 21, wherein the pore forming material or processing aid is methylcellulose.

24. The particulate adsorbent material of claim 21, wherein the pore forming material or processing aid sublimates, vaporizes, chemically decomposes, solubilizes or melts when heated to a temperature in a range of about 125° C. to about 640° C.

25. The particulate adsorbent material of claim 21, wherein the binder is clay or a silicate material.

26. The particulate adsorbent material of claim 25, wherein the clay is at least one of Zeolite clay, Bentonite clay, Montmorillonite clay, Illite clay, French Green clay, Pascalite clay, Redmond clay, Terramin clay, Living clay, Fuller's Earth clay, Ormalite clay, Vitallite clay, Rectorite clay, or a combination thereof.

27. The particulate adsorbent material of claim 1, wherein a packed bed of the particulate adsorbent material has a pressure drop that is <40 Pa/cm at 46 cm/s apparent linear air flow velocity.

28. A method of preparing a particulate adsorbent, the method comprising:
admixing an adsorbent with microscopic pores having a diameter less than about 100 nm and a pore forming material or processing aid that sublimates, vaporizes, chemically decomposes, solubilizes, or melts when heated to a temperature of 100° C. or more; and
heating the mixture to a temperature in a range of about 100° C. to about 1200° C. for about 0.25 hours to about 24 hours forming macroscopic pores having a diameter of about 100 nm or greater when the core material is sublimated, vaporized, chemically decomposed, solubilized, or melted,
wherein the particulate adsorbent has a ratio of a volume of the macroscopic pores to a volume of the microscopic pores that is greater than 150%.

29. The method of claim 28, further comprising extruding or compressing the admix into a shaped structure.

30. The method of claim 28, wherein the adsorbent is at least one of activated carbon, molecular sieves, porous alumina, clay, porous silica, zeolites, metal organic frameworks, or a combination thereof.

31. The method of claim 28, wherein the mixture further comprises a binder.

32. The method of claim 31, wherein the binder is at least one of clay, silicate or a combination thereof.

33. The method of claim 28, wherein the mixture further comprises a filler.

34. The method of claim 28, wherein the particulate adsorbent has a cross-sectional width in a range of about 1 mm to about 20 mm.

35. The method of claim 28, wherein the particulate adsorbent comprises a body defining an exterior surface and a three-dimensional low flow resistant shape or morphology.

36. The method of claim 35, wherein the three-dimensional low flow resistant shape or morphology is at least one of substantially a cylinder, substantially an oval prism, substantially a sphere, substantially a cube, substantially an elliptical prism, substantially a rectangular prism, a lobed prism, a three-dimensional helix or spiral, or a combination thereof.

37. The method of claim 28, wherein the particulate adsorbent includes at least one cavity or channel in fluid communication with an exterior surface of the particulate adsorbent.

38. The method of claim 28, wherein the particulate adsorbent has hollow shape in cross section.

39. The method of claim 28, wherein each part of the particulate adsorbent has a thickness of about 0.1 mm to about 3.0 mm.

40. The method of claim 38, wherein the hollow shape has at least one interior wall extending between the exterior walls.

41. The method of claim 40, wherein at least one of the interior walls, at least one of the exterior wall, or a combination thereof is about 0.1 mm to about 1.0 mm.

42. The method of claim 40, wherein the interior walls extend outward to the exterior wall in at least two directions from the interior volume, such as a center.

43. The method of claim 28, wherein the particulate adsorbent has a length of about 1 mm to about 20 mm.

44. The method of claim 28, wherein the particulate adsorbent has a retentivity of about 1.0 g/dL or less.

45. A particulate adsorbent material produced by the process of claim 28.
